(19) United States
(12) Patent Application Publication
(10) Pub. No.: US 2024/0015751 A1
(43) Pub. Date: Jan. 11, 2024

(54) ENHANCED IMPLICIT PUCCH RESOURCE INDICATION AND IDENTIFICATION TECHNIQUES

(71) Applicant: QUALCOMM Incorporated, San Diego, CA (US)

(72) Inventors: Wooseok Nam, San Diego, CA (US); Tao Luo, San Diego, CA (US); Sony Akkarakaran, Poway, CA (US); Xiaoxia Zhang, San Diego, CA (US); Jing Sun, San Diego, CA (US); Juan Montojo, San Diego, CA (US); Jun Ma, San Diego, CA (US); Anantha Krishna Karthik Nagarajan, San Diego, CA (US)

(21) Appl. No.: 18/246,010

(22) PCT Filed: Sep. 20, 2021
(86) PCT No.: PCT/US2021/071522

§ 371 Date: Mar. 20, 2023

Related U.S. Application Data
(60) Provisional application No. 63/080,651, filed on Sep. 18, 2020.

(51) Int. Cl. H04W 72/21; H04W 72/23; H04W 72/0453; H04W 72/0446

(52) U.S. Cl. CPC H04W 72/21; H04W 72/23; H04W 72/0453; H04W 72/0446

(57) ABSTRACT

Wireless communication techniques that include enhanced implicit PUCCH resource indication and identification techniques are discussed. A base station may transmit a PUCCH resource set that includes a plurality of PUCCH resources. A UE may receive a PUCCH resource set that includes a plurality of PUCCH resources. The base station may indicate a PUCCH resource of the plurality of PUCCH resources to use for uplink communication based on a PUCCH resource indicator and one or more additional parameters. A UE may identify a PUCCH resource of the plurality of PUCCH resources to use for uplink communication based, at least in part, on a PUCCH resource indicator and one or more additional parameters. Other aspects and features are also claimed and described.

### CROSS-REFERENCE TO RELATED APPLICATIONS

This application claims the benefit of U.S. Provisional Patent Application No. 63/080,651, entitled, “ENHANCED IMPLICIT PUCCH RESOURCE INDICATION AND IDENTIFICATION TECHNIQUES,” filed on Sep. 18, 2020 which is expressly incorporated by reference herein in its entirety.

### TECHNICAL FIELD

Aspects of the present disclosure relate generally to wireless communication systems, and more particularly, to enhanced implicit PUCCH resource indication and identification techniques. Certain aspects of the technology discussed below can enable and provide enhanced communication features and techniques for communication systems, including higher data rates, higher capacity, better spectral efficiency, higher reliability, and lower power device operations.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### SUMMARY

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication performed by a UE is provided. For example, a method can include receiving a physical uplink control channel (PUCCH) resource set that includes a plurality of PUCCH resources. The method can further include identifying a PUCCH resource of the plurality of PUCCH resources to use for uplink communication based, at least in part, on a PUCCH resource indicator and one or more additional parameters.

In another aspect of the disclosure, a UE configured for wireless communication is provided. For example, the UE can include means for receiving a PUCCH resource set that includes a plurality of PUCCH resources. The UE can also include means for identifying a PUCCH resource of the plurality of PUCCH resources to use for uplink communication based, at least in part, on a PUCCH resource indicator and one or more additional parameters.

In an additional aspect of the disclosure, a non-transitory computer-readable medium having program code recorded thereon is provided. The program code can include program code executable by a computer for causing the computer to receive a PUCCH resource set that includes a plurality of PUCCH resources. The program code can also include program code executable by the computer for causing the computer to identify a PUCCH resource of the plurality of PUCCH resources to use for uplink communication based, at least in part, on a PUCCH resource indicator and one or more additional parameters.

In another aspect of the disclosure, a UE is provided. The UE may include at least one processor. The UE may also include at least one memory communicatively coupled with the at least one processor and storing processor-readable code that, when executed by the at least one processor, is configured to receive a PUCCH resource set that includes a plurality of PUCCH resources. The at least one memory may further store processor-readable code that, when executed by the at least one processor, is configured to identify a PUCCH resource of the plurality of PUCCH resources to use for uplink communication based, at least in part, on a PUCCH resource indicator and one or more additional parameters.

In one aspect of the disclosure, a method for wireless communication performed by a base station is provided. For example, a method can include transmitting a PUCCH resource set that includes a plurality of PUCCH resources. The method can also include indicating a PUCCH resource of the plurality of PUCCH resources to use for uplink communication based, at least in part, on a PUCCH resource indicator and one or more additional parameters.

In another aspect of the disclosure, a base station configured for wireless communication is provided. For example, the base station can include means for transmitting a PUCCH resource set that includes a plurality of PUCCH resources. The base station can also include means for indicating a PUCCH resource of the plurality of PUCCH resources to use for uplink communication based, at least in part, on a PUCCH resource indicator and one or more additional parameters.

In an additional aspect of the disclosure, a non-transitory computer-readable medium having program code recorded thereon is provided. The program code can include program code executable by a computer for causing the computer to transmit a PUCCH resource set that includes a plurality of PUCCH resources. The program code can also include program code executable by the computer for causing the computer to indicate a PUCCH resource of the plurality of PUCCH resources to use for uplink communication based, at least in part, on a PUCCH resource indicator and one or more additional parameters.

In another aspect of the disclosure, a base station is provided. The base station may include at least one processor. The base station may also include at least one memory communicatively coupled with the at least one processor and storing processor-readable code that, when executed by the at least one processor, is configured to transmit a PUCCH resource set that includes a plurality of PUCCH resources. The at least one memory may further store processor-readable code that, when executed by the at least one processor, is configured to indicate a PUCCH resource of the plurality of PUCCH resources to use for uplink communication based, at least in part, on a PUCCH resource indicator and one or more additional parameters.

Other aspects, features, and embodiments will become apparent to those of ordinary skill in the art, upon reviewing the following description of specific, exemplary embodiments in conjunction with the accompanying figures. While features may be discussed relative to certain aspects and figures below, all embodiments can include one or more of the advantageous features discussed herein. In other words, while one or more aspects may be discussed as having certain advantageous features, one or more of such features may also be used in accordance with the various aspects. In similar fashion, while exemplary aspects may be discussed below as device, system, or method aspects, the exemplary aspects can be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label with a second label that distinguishes among the similar components. If just the first reference label is used in the specification, the description is applicable to any one of the similar components having the same first reference label irrespective of the second reference label.

FIG. 1 is a block diagram illustrating details of a wireless communication system according to some embodiments of the present disclosure.

FIG. 2 is a block diagram conceptually illustrating a design of a base station and a UE configured according to some embodiments of the present disclosure.

FIG. 3 is a block diagram illustrating a method for enhanced implicit PUCCH resource identification according to some aspects of the present disclosure.

FIG. 4 is a block diagram illustrating a method for enhanced implicit PUCCH resource indication according to some aspects of the present disclosure.

FIG. 5 is a block diagram conceptually illustrating a design of a UE configured according to some aspects of the present disclosure.

FIG. 6 is a block diagram conceptually illustrating a design of a base station (e.g., a gNB) configured according to some aspects of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks/systems/devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The Third Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with Universal Terrestrial Radio Access Networks (UTRANs) in the case of a UMTS/GSM network. Additionally, an operator network may also include one or more LTE networks, and/or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects descried with reference to one technology may be understood to be applicable to another technology. Indeed, one or more aspects of the present disclosure are related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD)/frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and/or other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or OEM devices or systems incorporating one or more described aspects. In some practical settings, devices incorporating described aspects and features may also necessarily include additional components and features for implementation and practice of claimed and described embodiments. It is intended that innovations described herein may be practiced in a wide variety of implementations, including both large/small devices, chip-level components, multi-component systems (e.g. RF-chain, communication interface, processor), distributed arrangements, end-user devices, etc. of varying sizes, shapes, and constitution.

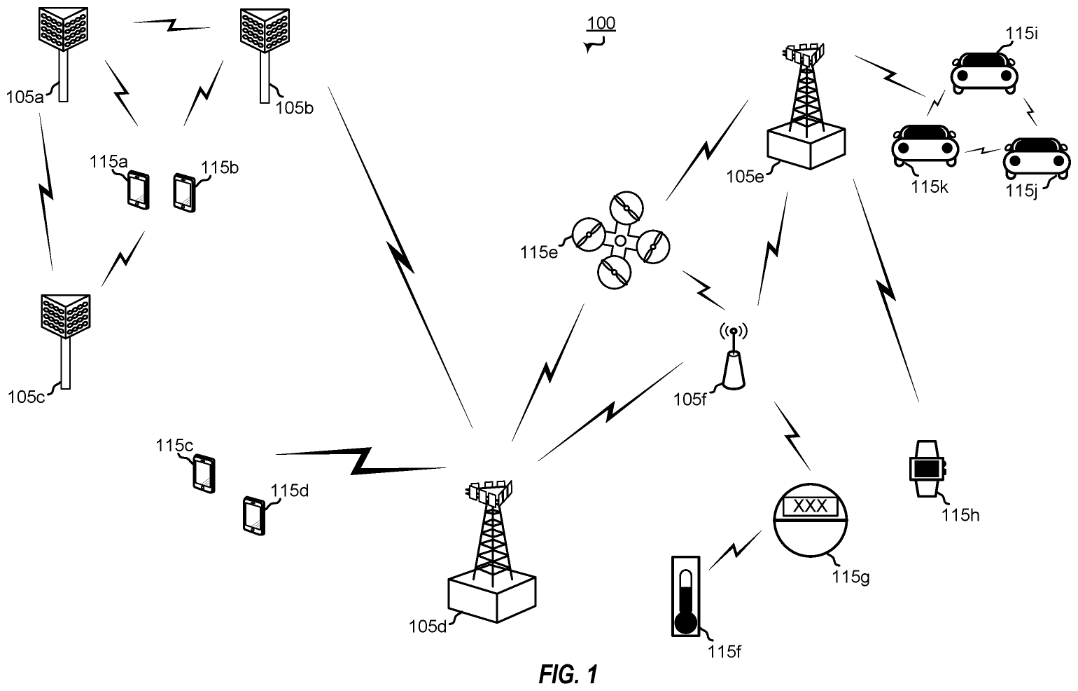

FIG. 1 is a block diagram illustrating details of an example wireless communication system. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station and/or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as user equipment (UE) in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component device/module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink and/or uplink, or desired transmission between base stations, and backhaul transmissions between base stations. UEs may operate as base stations or other network nodes in some scenarios. Backhaul communication between base stations of wireless network 100 may occur using wired and/or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD/FDD communications, such as in a vehicle-to-vehicle (V2V) mesh network between UEs 115i-115k communicating with macro base station 105e.

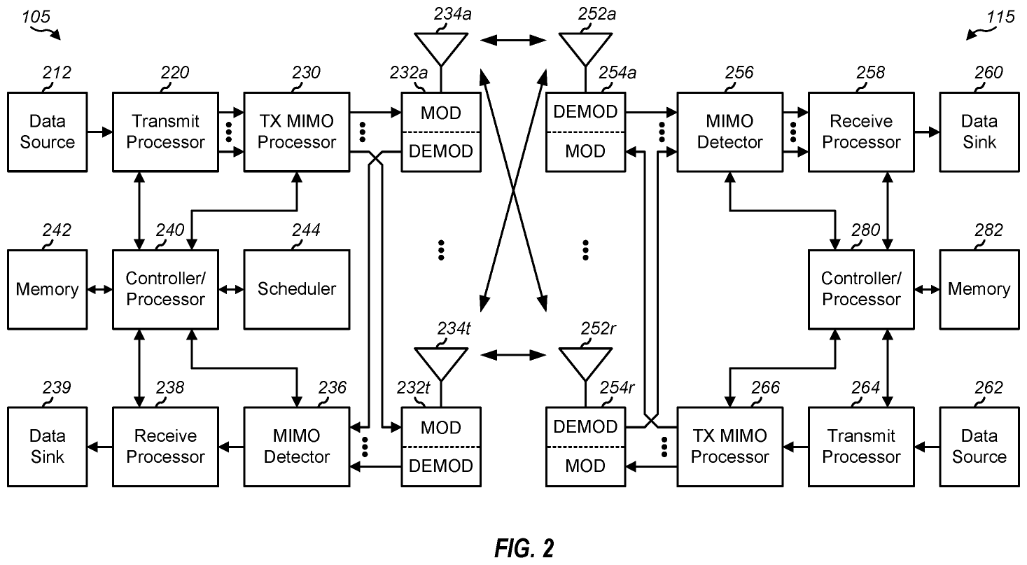

FIG. 2 shows a block diagram conceptually illustrating an example design of a base station 105 and a UE 115, which may be any of the base stations and one of the UEs in FIG. 1. For a restricted association scenario (as mentioned above), base station 105 may be small cell base station 105f in FIG. 1, and UE 115 may be UE 115c or 115D operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller/processor 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), MTC physical downlink control channel (MPDCCH), etc. The data may be for the PDSCH, etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) multiple-input multiple-output (MIMO) processor 230 may perform spatial processing (e.g., precoding) on the data symbols, the control symbols, and/or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, the antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller/processor 280.

On the uplink, at UE 115, transmit processor 264 may receive and process data (e.g., for the physical uplink shared channel (PUSCH)) from data source 262 and control information (e.g., for the physical uplink control channel (PUCCH)) from controller/processor 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Processor 238 may provide the decoded data to data sink 239 and the decoded control information to controller/processor 240.

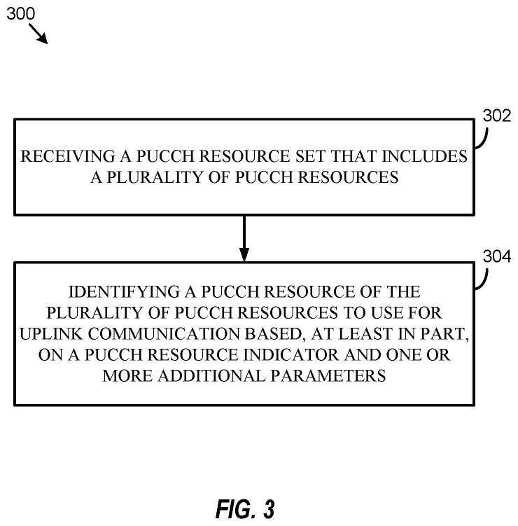

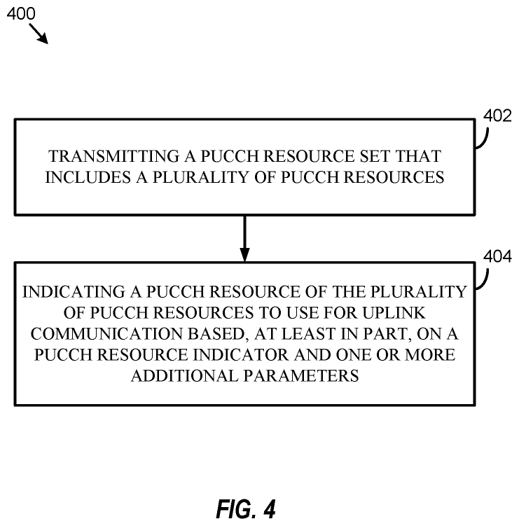

Controllers/processors 240 and 280 may direct the operation at base station 105 and UE 115, respectively. Controller/processor 240 and/or other processors and modules at base station 105 and/or controller/processor 280 and/or other processors and modules at UE 115 may perform or direct the execution of various processes for the techniques described herein, such as to perform or direct the execution illustrated in FIGS. 3 and 4, and/or other processes for the techniques described herein. Memories 242 and 282 may store data and program codes for base station 105 and UE 115, respectively. Scheduler 244 may schedule UEs for data transmission on the downlink and/or uplink.

Wireless communications systems operated by different network operating entities (e.g., network operators) may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel and/or the acknowledge/negative-acknowledge (ACK/NACK) feedback for its own transmitted packets as a proxy for collisions.

In some aspects of the disclosure, a base station, such as base station/gNB 105, may indicate a PUCCH resource for a UE to use for uplink communication. Similarly, a UE, such as UE 115, may identify the PUCCH resource to use for uplink communication. According to some aspects, the PUCCH resource may be implicitly indicated by the base station and/or identified by the UE. For example, one or more parameters may be used to implicitly indicate and/or identify the PUCCH resource to use for uplink communication. According to some aspects, through the use of many parameters to implicitly indicate and/or identify the PUCCH resource, limitations on some parameters may be offset by the advantage of using other parameters.

Aspects of this disclosure may provide enhanced implicit PUCCH resource indication and identification techniques. FIG. 3, as an example, shows a block diagram illustrating a method for enhanced implicit PUCCH resource identification according to some aspects of the present disclosure. Aspects of method 300 may be implemented with various other aspects of this disclosure described with respect to FIGS. 1-2 and 5, such as a mobile device/UE. For example, with reference to FIG. 2, controller/processor 280 of UE 115 may control UE 115 to perform method 300. FIG. 4, as another example, shows a block diagram illustrating a method for enhanced implicit PUCCH resource indication according to some aspects of the present disclosure. Aspects of method 400 may be implemented with various other aspects of this disclosure described with respect to FIGS. 1-2 and 6, such as a base station/gNB. For example, with reference to FIG. 2, controller/processor 240 of base station 105 may control base station 105 to perform method 400.

FIG. 3 illustrates a method 300 that may be performed by a UE, such as a UE 115, and FIG. 4 illustrates a method 400 that may be performed by a base station, such as a base station 105. At block 302, a UE, such as UE 115, may receive a PUCCH resource set that includes a plurality of PUCCH resources. Similarly, at block 402, a base station, such as base station 105, may transmit a PUCCH resource set that includes a plurality of PUCCH resources. In some aspects, each PUCCH resource of the plurality of PUCCH resources may provide different combinations of frequency and/or time resources to be used by the UE for uplink communication. For example, in some aspects, a PUCCH resource may be used by the UE to provide to the base station a hybrid automatic repeat request (HARQ) acknowledgement (ACK) or negative acknowledgement (NACK). According to some aspects, multiple PUCCH resource sets, such as four PUCCH resource sets, may be available to provide PUCCH resources to a UE. In some aspects, the PUCCH resource set disclosed at blocks 302 of FIGS. 3 and 402 of FIG. 4 may correspond to PUCCH resource set #0. According to some aspects, PUCCH resource set #0 may be utilized when the UE has a small data payload size to transmit to the base station, such as a payload size of one or two bits. In some aspects, PUCCH resource set #0 may include up to 32 PUCCH resources. According to some aspects, other PUCCH resource sets may include up to 8 PUCCH resources.

According to some aspects, which PUCCH resource to use for uplink communication may be indicated by the base station and/or identified by the UE. For example, as shown at block 304 of FIG. 3, method 300 may also include a UE identifying a PUCCH resource of the plurality of PUCCH resources to use for uplink communication based, at least in part, on a PUCCH resource indicator and one or more additional parameters. Similarly, as shown at block 404 of FIG. 4, method 400 may also include a base station indicating a PUCCH resource of the plurality of PUCCH resources to use for uplink communication based, at least in part, on a PUCCH resource indicator (PRI) and one or more additional parameters. According to some aspects, uplink communication may include a UE transmitting to a base station a HARQ ACK/NACK.

In some aspects, the PRI may be a 3-bit field. According to some aspects, the PRI may be a field provided in downlink control information (DCI) transmitted from a base station to a UE to be received by the UE. In some aspects, the PRI transmitted by the base station may indicate a sub-group of PUCCH resources of a PUCCH resource set. Therefore, a UE may identify a sub-group of the PUCCH resources based on the PRI.

According to some aspects, the one or more additional parameters shown at block 304 of FIG. 3 and block 404 of FIG. 4 may be used to indicate and/or identify a PUCCH resource, from the sub-group of PUCCH resources indicated and/or identified by the PRI, to use for uplink communication. In other words, in some aspects, the PRI and the one or more additional parameters may be jointly used to indicate and/or identify a PUCCH resource.

In some aspects, the one or more additional parameters may include at least one resource allocation parameter associated with a PDCCH. For example, in some aspects, the one or more additional parameters may include an index of a first control channel element (CCE) associated with the PDCCH. As an example, the CCE index may be of the first CCE of a control resource set (CORESET) of the PDCCH. According to some aspects, the first CCE index may be the lowest CCE index used for a CORESET of the PDCCH. In additional aspects, the one or more additional parameters may be an index of a search space set associated with a PDCCH.

According to some aspects, the one or more additional parameters may include at least one resource allocation parameter associated with a physical downlink shared channel (PDSCH). For example, in some aspects, the one or more additional parameters may include at least one of an indication of a frequency resource allocated for the PDSCH or an indication of a time resource allocated for the PDSCH. According to some aspects, the indication of a frequency resource allocated for the PDSCH may be a resource indicator value (RIV) provided in DCI transmitted from a base station to a UE to be received by the UE. In some aspects, the indication of a time resource allocated for the PDSCH may be a start and length indicator value (SLIV) provided in DCI transmitted from a base station to a UE to be received by the UE. According to some aspects, the SLIV may provide a combination of the starting symbol of a PDSCH and the length of the PDSCH allocation. In some aspects, the one or more additional parameters may include other resource allocation parameters associated with a PDSCH, such as a HARQ process ID, modulation and coding scheme (MCS), or rank.

In some aspects, the one or more additional parameters may include a time-domain index associated with a PDCCH, a PDSCH, or a PUCCH. For example, in some aspects, the time-domain index may be at least one of the system frame number, slot index, or symbol index associated with a PDCCH, a PDSCH, or a PUCCH. According to some aspects, the time-domain index may be the starting symbol index of a PDSCH in a slot. In some aspects, when there are four PUCCH resources in a sub-group selected by the PRI, the PUCCH resource with index “(PDSCH starting symbol index) modulo 4” may be selected for uplink communication, such as uplink HARQ-ACK/NACK communication.

According to some aspects, the one or more additional parameters may include the values of the additional parameters disclosed herein. In additional aspects, the one or more additional parameters may include the results of operations, e.g., modulo operations, performed on additional parameters disclosed herein. For example, when there are four PUCCH resources in a sub-group selected by the PRI, a modulo 4 parameter may be used with one or more of the additional parameters disclosed herein to indicate and/or identify a PUCCH resource, from the sub-group of PUCCH resources indicated and/or identified by the PRI, to use for uplink communication. As another example, when there are three PUCCH resources in a sub-group selected by the PRI, a modulo 3 parameter may be used with one or more of the additional parameters disclosed herein to indicate and/or identify a PUCCH resource, from the sub-group of PUCCH resources indicated and/or identified by the PRI, to use for uplink communication.

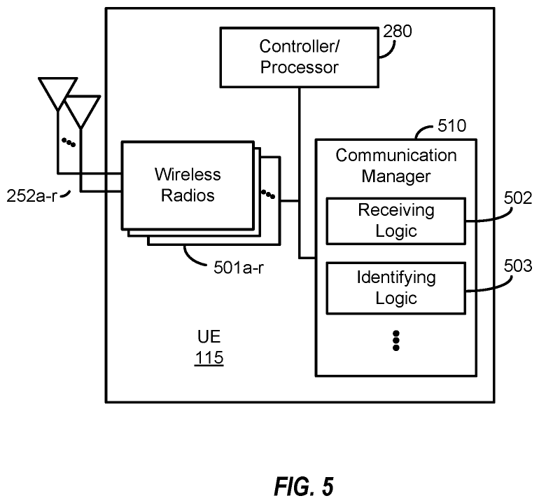

FIG. 5 shows a block diagram conceptually illustrating a design of a UE configured according to some aspects of the present disclosure. UE 115 may be configured to perform operations, including the blocks of the method 300 described with reference to FIG. 3. In some implementations, the UE 115 includes the structure, hardware, and components shown and described with reference to the UE 115 of FIG. 1 or 2. For example, the UE 115 includes the controller 280, which operates to execute logic or computer instructions illustrated in communication manager 510, as well as controlling the components of the UE 115 that provide the features and functionality of the UE 115. The UE 115, under control of the controller 280, transmits and receives signals via wireless radios 501a-r and the antennas 252a-r. The wireless radios 501a-r include various components and hardware, as illustrated in FIG. 2 for the UE 115, including the modulator and demodulators 254a-r, the MIMO detector 256, the receive processor 258, the transmit processor 264, and the TX MIMO processor 266.

Communication Manager 510 may include Receiving Logic 502 and Identifying Logic 503. Portions of one or more of the components 502 and 503 may be implemented at least in part in hardware or software. In some implementations, at least one of the components 502 and 503 is implemented at least in part as software stored in a memory (such as memory 282). For example, portions of one or more of the components 502 and 503 can be implemented as non-transitory instructions or code executable by a processor (such as the controller 280) to perform the functions or operations of the respective component.

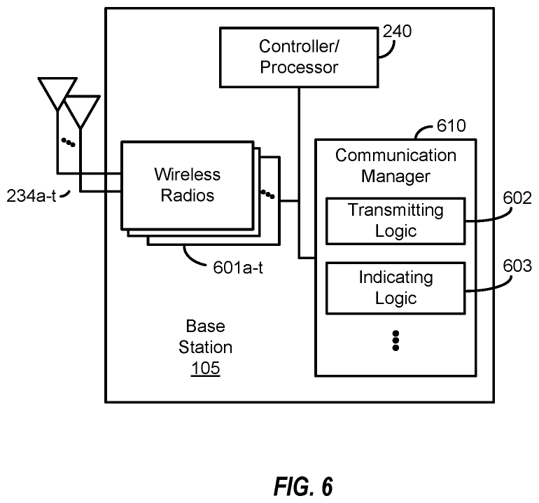

One or more of the components 502 and 503 illustrated in Communication Manager 510 may configure processor/controller 280 to carry out one or more procedures relating to wireless communication by the UE 115, as previously described. For example, Receiving Logic 502 may configure controller/processor 280 to carry out operations that include receiving a PUCCH resource set that includes a plurality of PUCCH resources, in any manner previously described, such as with reference to block 302 (see FIG. 3). Additionally, Identifying Logic 503 may configure controller/processor 280 to carry out operations that include identifying a PUCCH resource of the plurality of PUCCH resources to use for uplink communication based, at least in part, on a PUCCH resource indicator and one or more additional parameters, in any manner previously described, such as with reference to block 304 (see FIG. 3). The UE 115 may receive signals from or transmit signals to one or more network entities, such as the base station 105 of FIGS. 1-2 or a base station as illustrated in FIG. 6.

FIG. 6 shows a block diagram conceptually illustrating a design of a base station (e.g., a gNB) configured according to some aspects of the present disclosure. The base station 105 may be configured to perform operations, including the blocks of the method 400 described with reference to FIG. 4. In some implementations, the base station 105 includes the structure, hardware, and components shown and described with reference to the base station 105 of FIGS. 1-2. For example, the base station 105 may include the controller 240, which operates to execute logic or computer instructions illustrated in communication manager 610, as well as controlling the components of the base station 105 that provide the features and functionality of the base station 105. The base station 105, under control of the controller 240, transmits and receives signals via wireless radios 601a-t and the antennas 234a-t. The wireless radios 601a-t include various components and hardware, as illustrated in FIG. 2 for the base station 105, including the modulator and demodulators 232a-t, the transmit processor 220, the TX MIMO processor 230, the MIMO detector 236, and the receive processor 238.

Communication Manager 610 may include Transmitting Logic 602 and Indicating Logic 603. Portions of one or more of component 602 and 603 may be implemented at least in part in hardware or software. In some implementations, at least one of components 602 and 603 is implemented at least in part as software stored in a memory (such as memory 242). For example, portions of one or more of components 602 and 603 can be implemented as non-transitory instructions or code executable by a processor (such as the controller 240) to perform the functions or operations of the respective component.

One or more of components 602 and 603 illustrated in Communication Manager 610 may configure processor/controller 280 to carry out one or more procedures relating to wireless communication by the base station 105, as previously described. For example, Transmitting Logic 602 may configure controller/processor 280 to carry out operations that include transmitting a PUCCH resource set that includes a plurality of PUCCH resources, in any manner previously described, such as with reference to block 402 (see FIG. 4). Additionally, Indicating Logic 603 may configure controller/processor 280 to carry out operations that include indicating a PUCCH resource of the plurality of PUCCH resources to use for uplink communication based, at least in part, on a PUCCH resource indicator and one or more additional parameters, in any manner previously described, such as with reference to block 404 (see FIG. 4). The base station 105 may receive signals from or transmit signals to one or more UEs, such as the UE 115 of FIGS. 1-2 or the UE 115 of FIG. 5.

It is noted that one or more blocks (or operations) described with reference to FIGS. 3 and 4 may be combined with one or more blocks (or operations) described with reference to another of the figures. For example, one or more blocks (or operations) of FIG. 3 may be combined with one or more blocks (or operations) of FIG. 4. As another example, one or more blocks associated with FIG. 5 or 6 may be combined with one or more blocks (or operations) associated with FIG. 1 or 2.

In some aspects, enhanced implicit PUCCH resource indication and identification techniques may include a base station transmitting a PUCCH resource set that includes a plurality of PUCCH resources. Enhanced implicit PUCCH resource indication and identification techniques may also include a UE receiving a PUCCH resource set that includes a plurality of PUCCH resources. Enhanced implicit PUCCH resource indication and identification techniques may further include a base station indicating a PUCCH resource of the plurality of PUCCH resources to use for uplink communication based, at least in part, on a PUCCH resource indicator and one or more additional parameters. Enhanced implicit PUCCH resource indication and identification techniques may further include a UE identifying a PUCCH resource of the plurality of PUCCH resources to use for uplink communication based, at least in part, on a PUCCH resource indicator and one or more additional parameters.

Enhanced implicit PUCCH resource indication and identification techniques may include additional aspects, such as any single aspect or any combination of aspects described below and/or in connection with one or more other processes described elsewhere herein.

In a first aspect, the one or more additional parameters include at least one resource allocation parameter associated with a PDCCH.

In a second aspect, alone or in combination with the first aspect, the one or more additional parameters include an index of a first control channel element associated with the PDCCH.

In a third aspect, alone or in combination with one or more of the first and second aspects, the one or more additional parameters include at least one resource allocation parameter associated with a PDSCH.

In a fourth aspect, alone or in combination with one or more of the first through third aspects, the one or more additional parameters include at least one of: an indication of a frequency resource allocated for the PDSCH; or an indication of a time resource allocated for the PDSCH.

In a fifth aspect, alone or in combination with one or more of the first through fourth aspects, the one or more additional parameters include a time-domain index associated with a PDCCH, a PDSCH, or the PUCCH.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and modules described herein (e.g., the components, functional blocks, and modules in FIG. 2) may comprise processors, electronics devices, hardware devices, electronics components, logical circuits, memories, software codes, firmware codes, etc., or any combination thereof. In addition, features discussed herein may be implemented via specialized processor circuitry, via executable instructions, and/or combinations thereof.

Those of skill would further appreciate that the various illustrative logical blocks, modules, circuits, and algorithm steps (e.g., the logical blocks in FIGS. 3 and 4) described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication performed by a user equipment (UE), the method comprising:
receiving a physical uplink control channel (PUCCH) resource set that includes a plurality of PUCCH resources; and
identifying a PUCCH resource of the plurality of PUCCH resources to use for uplink communication based, at least in part, on a PUCCH resource indicator and one or more additional parameters.

2. The method of claim 1, wherein the one or more additional parameters include at least one resource allocation parameter associated with a physical downlink control channel (PDCCH).

3. The method of claim 2, wherein the one or more additional parameters include an index of a first control channel element associated with the PDCCH.

4. The method of claim 1, wherein the one or more additional parameters include at least one resource allocation parameter associated with a physical downlink shared channel (PDSCH).

5. The method of claim 4, wherein the one or more additional parameters include at least one of:
an indication of a frequency resource allocated for the PDSCH; or
an indication of a time resource allocated for the PDSCH.

6. The method of claim 1, wherein the one or more additional parameters include a time-domain index associated with a physical downlink control channel (PDCCH), a physical downlink shared channel (PDSCH), or the PUCCH.

7. The method of any combination of claims 1-6.

8. A user equipment (UE) configured for wireless communication, comprising:
means for receiving a physical uplink control channel (PUCCH) resource set that includes a plurality of PUCCH resources; and
means for identifying a PUCCH resource of the plurality of PUCCH resources to use for uplink communication based, at least in part, on a PUCCH resource indicator and one or more additional parameters.

9. The UE of claim 8, wherein the one or more additional parameters include at least one resource allocation parameter associated with a physical downlink control channel (PDCCH).

10. The UE of claim 9, wherein the one or more additional parameters include an index of a first control channel element associated with the PDCCH.

11. The UE of claim 8, wherein the one or more additional parameters include at least one resource allocation parameter associated with a physical downlink shared channel (PDSCH).

12. The UE of claim 11, wherein the one or more additional parameters include at least one of:
an indication of a frequency resource allocated for the PDSCH; or
an indication of a time resource allocated for the PDSCH.

13. The UE of claim 8, wherein the one or more additional parameters include a time-domain index associated with a physical downlink control channel (PDCCH), a physical downlink shared channel (PDSCH), or the PUCCH.

14. The UE of any combination of claims 8-13.

15. A non-transitory computer-readable medium having program code recorded thereon, the program code comprising:
program code executable by a computer for causing the computer to receive a physical uplink control channel (PUCCH) resource set that includes a plurality of PUCCH resources; and
program code executable by the computer for causing the computer to identify a PUCCH resource of the plurality of PUCCH resources to use for uplink communication based, at least in part, on a PUCCH resource indicator and one or more additional parameters.

16. The non-transitory computer-readable medium of claim 15, wherein the one or more additional parameters include at least one resource allocation parameter associated with a physical downlink control channel (PDCCH).

17. The non-transitory computer-readable medium of claim 16, wherein the one or more additional parameters include an index of a first control channel element associated with the PDCCH.

18. The non-transitory computer-readable medium of claim 15, wherein the one or more additional parameters include at least one resource allocation parameter associated with a physical downlink shared channel (PDSCH).

19. The non-transitory computer-readable medium of claim 18, wherein the one or more additional parameters include at least one of:
an indication of a frequency resource allocated for the PDSCH; or
an indication of a time resource allocated for the PDSCH.

20. The non-transitory computer-readable medium of claim 15, wherein the one or more additional parameters include a time-domain index associated with a physical downlink control channel (PDCCH), a physical downlink shared channel (PDSCH), or the PUCCH.

21. The non-transitory computer-readable medium of any combination of claims 15-20.

22. A user equipment (UE), comprising:
at least one processor; and
at least one memory communicatively coupled with the at least one processor and storing processor-readable code that, when executed by the at least one processor, is configured to:
receive a physical uplink control channel (PUCCH) resource set that includes a plurality of PUCCH resources; and
identify a PUCCH resource of the plurality of PUCCH resources to use for uplink communication based, at least in part, on a PUCCH resource indicator and one or more additional parameters.

23. The UE of claim 22, wherein the one or more additional parameters include at least one resource allocation parameter associated with a physical downlink control channel (PDCCH).

24. The UE of claim 23, wherein the one or more additional parameters include an index of a first control channel element associated with the PDCCH.

25. The UE of claim 22, wherein the one or more additional parameters include at least one resource allocation parameter associated with a physical downlink shared channel (PDSCH).

26. The UE of claim 25, wherein the one or more additional parameters include at least one of:
an indication of a frequency resource allocated for the PDSCH; or
an indication of a time resource allocated for the PDSCH.

27. The UE of claim 22, wherein the one or more additional parameters include a time-domain index associated with a physical downlink control channel (PDCCH), a physical downlink shared channel (PDSCH), or the PUCCH.

28. The UE of any combination of claims 22-27.

29. A method for wireless communication performed by a base station, the method comprising:
transmitting a physical uplink control channel (PUCCH) resource set that includes a plurality of PUCCH resources; and
indicating a PUCCH resource of the plurality of PUCCH resources to use for uplink communication based, at least in part, on a PUCCH resource indicator and one or more additional parameters.

30. The method of claim 29, wherein the one or more additional parameters include at least one resource allocation parameter associated with a physical downlink control channel (PDCCH).

31. The method of claim 30, wherein the one or more additional parameters include an index of a first control channel element associated with the PDCCH.

32. The method of claim 29, wherein the one or more additional parameters include at least one resource allocation parameter associated with a physical downlink shared channel (PDSCH).

33. The method of claim 32, wherein the one or more additional parameters include at least one of:
an indication of a frequency resource allocated for the PDSCH; or
an indication of a time resource allocated for the PDSCH.

34. The method of claim 29, wherein the one or more additional parameters include a time-domain index associated with a physical downlink control channel (PDCCH), a physical downlink shared channel (PDSCH), or the PUCCH.

35. The method of any combination of claims 29-34.

36. A base station configured for wireless communication, comprising:
means for transmitting a physical uplink control channel (PUCCH) resource set that includes a plurality of PUCCH resources; and
means for indicating a PUCCH resource of the plurality of PUCCH resources to use for uplink communication based, at least in part, on a PUCCH resource indicator and one or more additional parameters.

37. The base station of claim 36, wherein the one or more additional parameters include at least one resource allocation parameter associated with a physical downlink control channel (PDCCH).

38. The base station of claim 37, wherein the one or more additional parameters include an index of a first control channel element associated with the PDCCH.

39. The base station of claim 36, wherein the one or more additional parameters include at least one resource allocation parameter associated with a physical downlink shared channel (PDSCH).

40. The base station of claim 39, wherein the one or more additional parameters include at least one of:
an indication of a frequency resource allocated for the PDSCH; or
an indication of a time resource allocated for the PDSCH.

41. The base station of claim 36, wherein the one or more additional parameters include a time-domain index associated with a physical downlink control channel (PDCCH), a physical downlink shared channel (PDSCH), or the PUCCH.

42. The base station of any combination of claims 36-41.

43. A non-transitory computer-readable medium having program code recorded thereon, the program code comprising:
program code executable by a computer for causing the computer to transmit a physical uplink control channel (PUCCH) resource set that includes a plurality of PUCCH resources; and
program code executable by the computer for causing the computer to indicate a PUCCH resource of the plurality of PUCCH resources to use for uplink communication based, at least in part, on a PUCCH resource indicator and one or more additional parameters.

44. The non-transitory computer-readable medium of claim 43, wherein the one or more additional parameters include at least one resource allocation parameter associated with a physical downlink control channel (PDCCH).

45. The non-transitory computer-readable medium of claim 44, wherein the one or more additional parameters include an index of a first control channel element associated with the PDCCH.

46. The non-transitory computer-readable medium of claim 43, wherein the one or more additional parameters include at least one resource allocation parameter associated with a physical downlink shared channel (PDSCH).

47. The non-transitory computer-readable medium of claim 46, wherein the one or more additional parameters include at least one of:
an indication of a frequency resource allocated for the PDSCH; or
an indication of a time resource allocated for the PDSCH.

48. The non-transitory computer-readable medium of claim 43, wherein the one or more additional parameters include a time-domain index associated with a physical downlink control channel (PDCCH), a physical downlink shared channel (PDSCH), or the PUCCH.

49. The non-transitory computer-readable medium of any combination of claims 43-48.

50. A base station, comprising:
at least one processor; and
at least one memory communicatively coupled with the at least one processor and storing processor-readable code that, when executed by the at least one processor, is configured to:
transmit a physical uplink control channel (PUCCH) resource set that includes a plurality of PUCCH resources; and
indicate a PUCCH resource of the plurality of PUCCH resources to use for uplink communication based, at least in part, on a PUCCH resource indicator and one or more additional parameters.

51. The base station of claim 50, wherein the one or more additional parameters include at least one resource allocation parameter associated with a physical downlink control channel (PDCCH).

52. The base station of claim 51, wherein the one or more additional parameters include an index of a first control channel element associated with the PDCCH.

53. The base station of claim 50, wherein the one or more additional parameters include at least one resource allocation parameter associated with a physical downlink shared channel (PDSCH).

54. The base station of claim 53, wherein the one or more additional parameters include at least one of:
an indication of a frequency resource allocated for the PDSCH; or
an indication of a time resource allocated for the PDSCH.

55. The base station of claim 50, wherein the one or more additional parameters include a time-domain index associated with a physical downlink control channel (PDCCH), a physical downlink shared channel (PDSCH), or the PUCCH.

56. The base station of any combination of claims 50-55.
